(19) United States
(12) Patent Application Publication
(10) Pub. No.: US 2007/0101629 A1
(43) Pub. Date: May 10, 2007

(54) Apparatus for use in beauty salons

(76) Inventor: Ayfer Deniz, Wayne, NJ (US)

Correspondence Address: THEODORE JAY;SUITE 600, 16 N CHATSWORTH AVE., LARCHMONT, NY, 10538, US

(21) Appl. No.: 11/268,339

(22) Filed: Nov. 7, 2005

(51) Int. Cl. G09F 3/16

(52) U.S. Cl. 40/666

(57) ABSTRACT

Apparatus comprising: first and second separate elongated flexible members with first first and second opposite ends. An elongated hinge interconnecting the second ends of the first and second members and extends between horizontally between them. The hinge urges the free lower ends of both first and second members toward each other. The hinge has a recessed central region. A third member has upper and lower edges with a hinge connector secured to the lower edge. The connector engages the recessed central region of the hinge and is pivotally secured to the hinge.

### FIELD OF THE INVENTION

The present invention is directed toward apparatus for use by operatives in beauty salons who in response to requests of clients for different color styling apply fluids of different colors to their hair. Some clients require the application of two or more colors which can vary in intensity and volume.

### BACKGROUND OF THE INVENTION

Since the desired colors can vary in intensity and volume, and clients can often be demanding, it is very difficult for an operator to avoid errors in selection and application. To this end, each different color is stored in a separate vessel such as a color pot. The colors often oxidize, which makes the selection of the correct color even more difficult.

The invention disclosed in this application provides an accurate identification apparatus connected to each pot and carrying accurate and readable identification of the color therein.

### SUMMARY OF THE INVENTION

In accordance with the principles of this invention, apparatus for providing such accurate and removable means incorporates first and second closely spaced elongated flexible members. Each first and second member has first and second opposite ends.

An elongated hinge interconnects the first ends of the two members and extends horizontally between them. The hinge urges the opposite ends of both members, which are free to move, toward each other. The hinge has a depressed central region.

A third member having a flat face has upper and lower edges with a hinge connector secured to the lower edge. The hinge connector engages the recessed central region of the hinge and is pivotally secured to said hinge.

In use, a separate one of these apparatus is connected detachably to a corresponding one of the color containing pots. In use, the first and second members under the influence of the hinge detachably clamp and engage opposite sides of a portion of the wall of the corresponding pot. Depending upon the location of the wall, the two members can extend horizontally or vertically.

The third member can be pivoted to a position above the pot and its flat face displays information identifying the contents of the pot.

Additional objects and advantages of this invention will be explained with reference to the drawings and detailed description which follow.

### BRIEF DESCRIPTION OF THE DRAWINGS

FIG. 1 is a partially exploded view of a preferred embodiment of the invention.

FIG. 2 is a side view of the embodiment of FIG. 1 as assembled.

FIG. 3 is a perspective view illustrating the invention in use.

FIG. 4 is a detail view taken along the line 4-4 in FIG. 3.

FIG. 5 is a perspective view of the third member used in the invention.

### DETAILED DESCRIPTION OF PREFERRED EMBODIMENT

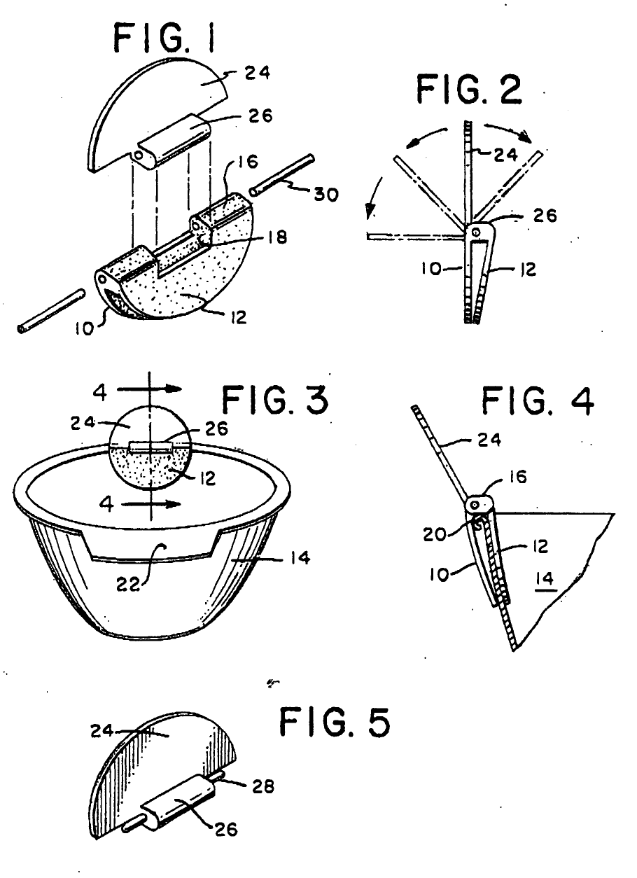

Referring now to FIGS. 1-5, first and second elongated flexible members 10 and 12 are closely spaced and have free lower ends. These members are formed of plastic and are coated with rubber to promote detachable non-slidable connection to the wall of a color pot 14. The rubber will not interact with or contaminate the color contents of the pot. The members are shaped to detachably engage and conform to the inner and outer surfaces of the selected portion of the wall of the pot.

An elongated flexible plastic hinge 16 interconnects the upper ends of the two members and extends horizontally between them. The hinge urges the free lower ends toward each other. The hinge has a depressed central region 18. Since the pot wall may have a lip 20 or other extension 22, the width of the hinge is adjusted to accommodate these elements. While the members are shown vertically disposed in the drawings, these members can be oriented horizontally to engage extension 22.

A third plastic member 24 has a flat face and upper and lower edges with a hinge connector 26 secured to the lower edge. The hinge connector horizontally engages the recessed central region of the hinge with an elongated pin 30 extending through connector and hinge pivotally securing me8 on engaging suitable opposite recesses in the hinge. mber and hinge. Alternatively, the connector can be molded of rubber with opposite pins 28. The flat surface of the member 24 can display color information or the like to assist an operator to use the correct color contents of the bow as desired.

While the invention has been described with particular emphasis on the drawings and detailed description, the protection solicited is to be limited only by the terms of the claims which follow.

What is claimed is:

1. Apparatus for use by operatives in beauty salons, said apparatus comprising:
first and second separate elongated flexible members, each of said first and second members having first and second opposite ends, the first ends of both first and second members being free to move toward and away from each other;
an elongated hinge interconnecting the second ends of the first and second members and extending between horizontally between them, said hinge having a depressed central region. said hinge urging the free lower ends of both first and second members toward each other; and.
a third member having upper and lower edges with a hinge connector secured to the lower edge, said hinge connector engaging the recessed central region of the hinge and being pivotally secured to said hinge, said third member having a flat face adapted to display color information.

2. Apparatus of claim 1 wherein the first and second members extend horizontally and engage a portion of a wall of a color pot with said portion being disposed between the members.

3. Apparatus of claim 1 wherein the first and second members extend vertically and engage a portion of a wall of a color pot with said portion being disposed between the members.

4. Apparatus of claim 1 wherein the members, hinge and connector are all composed of plastic.

5. Apparatus of claim 4 wherein the first and second members are coated with rubber.

6. Apparatus of claim 1 wherein the connector has oppositely extending pins which engage corresponding opposite recesses in the hinge.
